(19) United States
(12) Patent Application Publication
(10) Pub. No.: US 2010/0149463 A1
(43) Pub. Date: Jun. 17, 2010

(54) LIQUID CRYSTAL DISPLAY PANEL, LIQUID CRYSTAL DISPLAY DIVICE PROVIDED WITH SAME, AND BONDING SUBSTRATE FOR LIQUID CRYSTAL DISPLAY PANEL

(75) Inventors: Takashi Shimizu, Kirishima-shi (JP); Yoshio Miyazaki, Kirishima-shi (JP); Kengou Aoki, Kirishima-shi (JP); Toshirou Motomura, Kirishima-shi (JP)

Correspondence Address: BIRCH STEWART KOLASCH & BIRCH, PO BOX 747, FALLS CHURCH, VA, 22040-0747, US

(73) Assignee: KYOCERA CORPORATION, KYOTO (JP)

(21) Appl. No.: 12/088,427

(22) PCT Filed: Sep. 28, 2006
(86) PCT No.: PCT/JP2006/319389

§ 371 Date: Jun. 30, 2008

(30) Foreign Application Priority Data
Sep. 29, 2005 (JP) 2005-283785
Mar. 29, 2006 (JP) 2006-090343

(51) Int. Cl. G02F 1/1335; G02F 1/1339

(52) U.S. Cl. 349/106; 349/155; 349/153

(57) ABSTRACT

The invention relates to a liquid crystal display panel 2 including a first base having a light shielding film 45, color filters 46R, 46G, 46B, 46, and a first display electrode 48 on a first transparent substrate 4; a second base 5 having a second display electrode 51 on a second transparent substrate 50, spacers 20 and 21 for keeping a distance between the first and the second bases 4 and 5; and a sealing member 6 for sealing a liquid crystal between the first and the second bases 4 and 5. At least one of the first and the second bases 4 and 5 includes a convex portion 43 between a display region 40 including display pixels and a sealing region 41 sealed by the sealing member 6, to enclose the display region 40 with the convex portion 43. The spacers 20 and 21 include a first spacer 20 in the display region 40 and a second spacer 21 on the convex portion.

### RELATED APPLICATIONS

This application is the National Phase under 35 U.S.C. §371 of PCT International Application No. PCT/JP2006/319389 which has an International filing date of Sep. 28, 2006, which claims priority to Japanese Application No. 2005-283785 filed on Sep. 29, 2005. The entire contents of all applications listed above are hereby incorporated by reference.

### TECHNICAL FIELD

The present invention relates to a color liquid crystal display panel having a color filter, a liquid crystal display device provided with the same, and a laminated substrate for liquid crystal display panels.

### BACKGROUND ART

In recent years, liquid crystal display devices including liquid crystal display panels have been widely applied not only to relatively small information communication devices such as portable information terminals, but also to relatively large electric devices such as monitors and car navigation apparatuses. Such a liquid crystal display panel typically has a structure in which a liquid crystal layer is interposed between a pair of transparent substrates having electrodes to apply voltages to a liquid crystal. The liquid crystal layer is held between the pair of transparent substrates by a sealing member at the periphery of a display region including a plurality of pixel portions.

With the liquid crystal display panel having the structure, display irregularity caused by variation of the thickness of the liquid crystal layer may appear. In particular, the thickness of the liquid crystal layer likely varies at an outer portion of the display region including the plurality of pixel portions. To reduce the display irregularity caused by the variation of the thickness of the liquid crystal layer, various solutions are suggested (for example, see Patent Document 1).

The liquid crystal display panel is typically obtained as follows. First, as shown in FIG. 21A, first spacers 96 are dispersed on a mother base 95A, which is one of a pair of mother bases 95A and 95B having display electrodes, alignment films, and the like. Sealing members 98 made of thermosetting resin including spacers 97 are applied to the other mother base 95B. The spacers 96 may be, for example, spherical spacers made of resin. The spacers 97 may be typically columnar glass fiber or spherical silica particles having a large compressive elastic modulus so as to accurately keep a gap between the mother bases 95A and 95B by the sealing members 98. Then, the pair of mother bases 95A and 95B are aligned to face to each other, and bonded by thermo compression bonding as shown in FIG. 21B, to cure the thermosetting resin of the sealing members 98. Thus, the pair of mother bases 95A and 95B are bonded together, and a laminated substrate 99 for liquid crystal display panels is obtained. Finally, the laminated substrate 99 for liquid crystal display panels is cut at predetermined cutting lines, and accordingly, a plurality of liquid crystal display panels are obtained.

In general, if the compressive elastic modulus of the spacers 96 is small, it is difficult to produce the liquid crystal display panel with the gap (thickness of the liquid crystal layer) kept uniform. The liquid crystal display panel may be easily deformed when an external force is applied, and hence the thickness of the liquid crystal layer may vary, causing display irregularity. On the other hand, if the compressive elastic modulus of the spacers 96 is large, low-temperature air bubbles tend to be generated. Herein, the low-temperature air bubbles are air bubbles generated such that a space is generated in the liquid crystal layer when the liquid crystal display panel is placed in a low-temperature environment (for example, −10° C. or lower), gas is generated when an external force is applied to the liquid crystal display panel, and the gas remains even when the temperature becomes a normal temperature. That is, in the low-temperature environment, the apparent volume of the liquid crystal decreases. If the compressive elastic modulus of the spacers 96 is so large that the deformation thereof is not sufficient, a space is likely generated in the liquid crystal layer. Thus, the low-temperature air bubbles are likely generated. Therefore, the spacers 96 typically employ resin spherical spacers having a smaller compressive elastic modulus than that of the spacers 97.

[Patent Document 1] Japanese Unexamined Patent Application Publication No. 01-269917

### DISCLOSURE OF INVENTION

### Problems to be Solved by the Invention

However, when the spacers 96 having a smaller compressive elastic modulus than the spacers 97 are used, as shown in FIG. 22A, the spacers 96 are markedly deformed around the sealing members 98 (spacers 97) during the thermo compression bonding. The thickness D of the liquid crystal layer in the display region becomes small as compared with the thickness near the sealing members 98. The thermosetting resin of the sealing members 98 may be cured with the first mother base 95B depressed. As shown in FIG. 22B, when a load is removed after the thermosetting of the sealing members 98, the thickness D of the liquid crystal layer in the display region is elastically recovered to a predetermined gap because of the elasticity of the first spacers 96, however, the thickness D of the liquid crystal layer in the region near the sealing members 98 (outer portion of the display region) is affected by the thermosetting of the sealing members 98, and hence, the elastic recovery of the spacers 96 is insufficient. Owing to this, the thickness D of the liquid crystal layer at the outer portion of the display region becomes small, as compared with the thickness at the center portion. Therefore, if the spacers 96 having a smaller compressive elastic modulus than the spacers 97 are used, it is difficult to keep the thickness D of the liquid crystal layer uniform over the entire display region.

An object of the present invention is to keep a thickness of a liquid crystal layer in a display region uniform, and to reduce display irregularity caused by a depression at an outer portion of the display region.

### Means for Solving the Problems

According to a first aspect of the present invention, a liquid crystal display panel is provided, which includes a first base including a light shielding film, a plurality of color filters, and a first display electrode on a first transparent substrate; a second base including a second display electrode on a second transparent substrate; a plurality of spacers for keeping a distance between the first and the second bases; and a sealing member for sealing a liquid crystal between the first and the second bases. At least one of the first and the second bases includes a convex portion between a display region including a plurality of display pixels and a sealing region sealed by the sealing member. The convex portion encloses the display region. The spacers include a first spacer in the display region and a second spacer on the convex portion.

The convex portion may have a frame shape.

The color filters may include a first color filter for display in an opening of the light shielding film and a second color filter on the light shielding film, for forming the convex portion.

According to a second aspect of the present invention, a liquid crystal display panel is provided, which includes a first base including a light shielding film, a plurality of color filters, and a first display electrode on a first transparent substrate; a second base including a second display electrode on a second transparent substrate; a plurality of spacers for keeping a distance between the first and the second bases; and a sealing member for sealing a liquid crystal between the first and the second bases. The spacers include a first spacer in a display region including a plurality of display pixels and a second spacer between the display region and a sealing region sealed by the sealing member. The second spacer has a larger elastic deformation ratio than the first spacer.

According to a third aspect of the present invention, a liquid crystal display panel is provided, which includes a first base including a light shielding film, a plurality of color filters, and a first display electrode on a first transparent substrate; a second base including a second display electrode on a second transparent substrate; a plurality of substantially spherical or spheroidal spacers for keeping a distance between the first and the second bases; and a sealing member for sealing a liquid crystal between the first and the second bases. The spacers include a first spacer in the display region and a second spacer between the display region and a sealing region sealed by the sealing member. The second spacer has a larger aspect ratio than the first spacer.

The sealing member may include a third spacer. The third spacer may preferably have a larger compressive elastic modulus than the first and the second spacers.

According to a fourth aspect of the present invention, a liquid crystal display device is provided, which includes a liquid crystal display panel including a first base and a second base; and a back light facing to the first base or the second base. The first base includes a light shielding film, a plurality of color filters, and a first display electrode on a first transparent substrate. The second base includes a second display electrode on a second transparent substrate. The liquid crystal display panel includes a sealing member for sealing a liquid crystal between the first and the second bases and a plurality of spacers for keeping a distance between the first and the second bases. At least one of the first and the second bases includes a convex portion between a display region including a plurality of display pixels and a sealing region sealed by the sealing member. The convex portion encloses the display region. The spacers include a first spacer in the display region and a second spacer on the convex portion.

The convex portion may have a frame shape.

The color filters may include a first color filter for display in an opening of the light shielding film and a second color filter on the light shielding film, for forming the convex portion.

According to a fifth aspect of the present invention, a liquid crystal display device is provided, which includes a liquid crystal display panel including a first base and a second base; and a back light facing to the first base or the second base. The first base includes a light shielding film, a plurality of color filters, and a first display electrode on a first transparent substrate. The second base includes a second display electrode on a second transparent substrate. The liquid crystal display panel includes a sealing member for sealing a liquid crystal between the first and the second bases and a plurality of spacers for keeping a distance between the first and the second bases. The spacers include a first spacer in a display region including a plurality of display pixels and a second spacer between the display region and a sealing region sealed by the sealing member. The second spacer has a larger elastic deformation ratio than the first spacer.

According to a sixth aspect of the present invention, a liquid crystal display device is provided, which includes a liquid crystal display panel including a first base and a second base; and a back light facing to the first base or the second base. The first base includes a light shielding film, a plurality of color filters, and a first display electrode on a first transparent substrate. The second base includes a second display electrode on a second transparent substrate. The liquid crystal display panel includes a sealing member for sealing a liquid crystal between the first and the second bases and a plurality of substantially spherical or spheroidal spacers for keeping a distance between the first and the second bases. The spacers include a first spacer in a display region including a plurality of display pixels and a second spacer between the display region and a sealing region sealed by the sealing member. The second spacer has a larger aspect ratio than the first spacer.

The sealing member may include a third spacer. The third spacer may preferably have a larger compressive elastic modulus than the first and the second spacers.

According to a seventh aspect of the present invention, a laminated substrate for liquid crystal display panels is provided, which includes a first mother base including light shielding films, color filters, and first display electrodes on a first transparent mother substrate; a second mother base including second display electrodes on a second transparent mother substrate; spacers for keeping a distance between the first and the second mother bases; and sealing members for sealing liquid crystals between the first and the second mother bases. At least one of the first and the second mother bases includes convex portions between display regions including display pixels and sealing regions sealed by the sealing members. The convex portions enclose the display regions. The spacers include first spacers in the display regions and second spacers on the convex portions.

The convex portions may have a frame shape.

The color filters may include first color filters for display in openings of the light shielding films, and second color filters on the light shielding films, for forming the convex portions.

At least one of the first and the second mother bases further includes second convex portions in regions enclosing the sealing regions. The spacers may preferably include fourth spacers on the second convex portions.

According to an eighth aspect of the present invention, a laminated substrate for liquid crystal display panels is provided, which includes a first mother base including light shielding films, color filters, and first display electrodes on a first transparent mother substrate; a second mother base including second display electrodes on a second transparent mother substrate; spacers for keeping a distance between the first and the second mother bases; and sealing members for sealing liquid crystals between the first and the second mother bases. The spacers include first spaces between display regions including display pixels and second spacers between the display regions and sealing regions sealed by the sealing members. The second spacers have a larger elastic deformation ratio than the first spacers.

According to a ninth aspect of the present invention, a laminated substrate for liquid crystal display panels is provided, which includes a first mother base including light shielding films, color filters, and first display electrodes on a first transparent mother substrate; a second mother base including second display electrodes on a second transparent mother substrate; spacers for keeping a distance between the first and the second mother bases; and sealing members for sealing liquid crystals between the first and the second mother bases. The spacers include first spaces between display regions including display pixels and second spacers between the display regions and sealing regions sealed by the sealing members. The second spacers have a larger aspect ratio than the first spacers.

The sealing members may include third spacers. The third spacer may preferably have a larger compressive elastic modulus than the first and the second spacers.

### ADVANTAGES

In one aspect of the present invention, the liquid crystal display panel is provided, in which the convex portion is provided in the peripheral region between the display region and the sealing member (sealing region), and the second spacers are provided on the convex portion. In the liquid crystal display panel, a load is applied by the second spacers to the convex portion, in a direction widening a gap between the first and second bases (thickness of the liquid crystal layer). The load applied to the convex portion is larger than a load applied to the display region by the first spacers. Accordingly, the depression in the peripheral region is shallower. As a result, the depression at the outer portion of the display region can be shallower. Thus, in the liquid crystal display panel of one aspect of the present invention, the thickness of the liquid crystal layer can be kept uniform over the entire display region, and the display irregularity can be reduced at the outer portion of the display region. Also, the convex portion can be formed in the peripheral region (that is, a not-used space) between the display region and the sealing region and not contributing to displaying of an image. A region for the convex portion does not have to be additionally provided, and the liquid crystal display panel would not become large.

In the liquid crystal display panel of one aspect of the present invention, if the convex portion has a frame shape, the depression in the entire peripheral region of the display region can be shallower, and the depression at the entire outer portion of the display region can be shallower. As a result, in the liquid crystal display panel of one aspect of the present invention, the thickness of the liquid crystal layer can be further reliably kept uniform. The display irregularity can be further reliably reduced at the outer portion of the display region.

The exemplary convex portion of the liquid crystal display panel of one aspect of the present invention can be formed merely by providing the light shielding film also in the peripheral region, and providing the color filter at a predetermined position on the light shielding film in the peripheral region. The light shielding film and the color filter are required to the liquid crystal display panel. Therefore, with the liquid crystal display panel of one aspect of the present invention, the gap in the display region can be kept uniform, and the display irregularity can be reduced at the outer portion of the display region, without increasing the manufacturing worker-hour.

Also, one aspect of the present invention provides the liquid crystal display panel in which the elastic deformation ratio or the aspect ratio of the second spacers in the peripheral region between the display region and the sealing member (sealing region) is larger than that of the first spacers. In such a liquid crystal display panel, since the elastic deformation ratio or the aspect ratio of the second spacers is larger than that of the first spacers, the elastic resilience by the second spacers becomes larger. Accordingly, a load applied to the peripheral region with the second spacers increases in a direction widening the gap (liquid crystal layer) between the first and second bases, as compared with a load applied to the display region. Hence, the depression in the peripheral region can be shallower, and the depression at the outer portion of the display region can be shallower. As a result, in the liquid crystal display device of one aspect of the present invention, the thickness of the liquid crystal layer can be kept uniform. The display irregularity can be reduced at the outer portion of the display region. This advantage may be attained by positioning the second spacers having the larger elastic deformation ratio or the larger aspect ratio than the first spacers, in the peripheral region (that is, a not-used space) between the display region and the sealing region and not contributing to displaying of an image. A region for the second spacers does not have to be additionally provided. The liquid crystal display panel would not become large.

In the liquid crystal display panel of one aspect of the present invention, since the third spacers having a larger compressive elastic modulus than the first and second spacers are used, the thickness of the sealing member can be kept uniform. Accordingly, when an external force is applied to the liquid crystal display panel, the sealing member is hardly deformed. The display irregularity caused by the variation of the thickness of the liquid crystal layer can be reduced.

The liquid crystal display device of one aspect of the present invention uses the liquid crystal display panel including the convex portion in the peripheral region of the display region, or the liquid crystal display panel in which the elastic deformation ratio or the aspect ratio of the second spacers in the region between the display region and the sealing member (sealing region) is larger than that of the first spacer. With this liquid crystal display panel, as described above, the panel would not become large, and the depression at the outer portion of the display region can be shallower. Therefore, with the liquid crystal display device of one aspect of the present invention, the device would not become large, and the display irregularity can be reduced at the outer portion of the display region.

In the liquid crystal display device of one aspect of the present invention, since the liquid crystal display panel employs the convex portion having a frame shape, the depression at the entire outer portion of the display region can be shallower. The thickness of the liquid crystal layer can be further reliably kept uniform, and the display irregularity can be reduced at the outer portion of the display region.

In the liquid crystal display device of one aspect of the present invention, since the liquid crystal display panel employs the convex portion which is formed by providing the color filter on the light shielding film at the portion corresponding to the peripheral region, the thickness of the liquid crystal layer in the display region can be kept uniform, and the display irregularity caused by the depression at the outer portion of the display region can be reduced without increasing the manufacturing worker-hour.

In the liquid crystal display panel of one aspect of the present invention, since the third spacers have the larger compressive elastic modulus than the first and second spacers, the thickness of the sealing member can be kept uniform. Accordingly, when an external force is applied to the liquid crystal display device, the sealing member is hardly deformed. The display irregularity caused by the variation of the thickness of the liquid crystal layer can be reduced.

The liquid crystal display panels can be obtained by cutting the laminated substrate for liquid crystal display panels of one aspect of the present invention. In such liquid crystal display panels, the convex portion is provided in the peripheral region of the display region, or the elastic deformation ratio or the aspect ratio of the second spacers in the region between the display region and the sealing member (sealing region) is larger than that of the first spacers. Accordingly, the liquid crystal display panels can be obtained from the laminated substrate for liquid crystal display panels, which would not be large and which can reduce the depth of the depression at the outer portion of the display region from being depressed, as described above.

In the laminated substrate for liquid crystal display panels of one aspect of the present invention, since the second convex portion is provided in the region enclosing the periphery of the sealing region and the fourth spacers are positioned on the second convex portion, the depression in the periphery of the sealing region can be shallower. Accordingly, with the liquid crystal display panels obtained by cutting the laminated substrate for liquid crystal display panels, the depression in the peripheral region between the sealing region and the display region can be shallower because of the depression in the region enclosing the sealing region. As a result, with the laminated substrate for liquid crystal display panels of one aspect of the present invention, the depression at the outer portion of the display region can be further reliably shallower, and the display irregularity caused by the variation of the thickness of the liquid crystal layer can be further reliably reduced.

### BRIEF DESCRIPTION OF DRAWINGS

FIG. 1 is a perspective overview showing an exemplary liquid crystal display device according to the present invention.

FIG. 2 is a cross section taken along a line II-II in FIG. 1.

FIG. 3 is an enlarged cross section showing a part enclosed by a dotted chain line in FIG. 2.

FIG. 4 is a perspective overview showing a first base.

FIG. 5 illustrates cross sections showing the part similar to FIG. 3 to explain other examples of a second color filter for a convex portion in the first base.

FIG. 6 illustrates cross sections to explain manufacturing sub-steps of a first mother base in a manufacturing method of a liquid crystal display panel for the liquid crystal display device in FIG. 1.

FIG. 7 illustrates cross sections to explain manufacturing sub-steps of the first mother base in the manufacturing method of the liquid crystal display panel for the liquid crystal display device in FIG. 1.

FIG. 8 illustrates cross sections to explain manufacturing sub-steps of the first mother base in the manufacturing method of the liquid crystal display panel for the liquid crystal display device in FIG. 1.

FIG. 9 illustrates cross sections to explain manufacturing sub-steps of the first mother base in the manufacturing method of the liquid crystal display panel for the liquid crystal display device in FIG. 1.

FIG. 10 illustrates cross sections to explain manufacturing sub-steps of the first mother base in the manufacturing method of the liquid crystal display panel for the liquid crystal display device in FIG. 1.

FIG. 11 illustrates cross sections to explain manufacturing sub-steps of a second mother base in the manufacturing method of the liquid crystal display panel for the liquid crystal display device in FIG. 1.

FIG. 12 is a perspective overview when sealing members are formed on the second mother base with first spacers dispersed.

FIG. 13 is a perspective view to explain a sub-step of bonding the first and second mother bases.

FIG. 14 illustrates cross sections to explain the sub-step of bonding the first and second mother bases.

FIG. 15A is an enlarged cross section showing a part enclosed by a dotted chain line in FIG. 14A, and FIG. 15B is an enlarged cross section showing a part enclosed by a dotted chain line in FIG. 14B.

FIG. 16A is a cross section showing the part enclosed by a dotted chain line in FIG. 14A, when a load, applied in FIG. 15A, is removed, and FIG. 16B is a cross section showing the part enclosed by a dotted chain line in FIG. 14B, when a load, applied in FIG. 15B, is removed.

FIG. 17A is a cross section to explain a cutting line along the Y direction, and FIG. 17B is a cross section to explain a cutting line along the X direction.

FIG. 18A illustrates the result when the thickness of a liquid crystal layer in the X direction for an example of the liquid crystal display panel according to one embodiment of the present invention is measured, and FIG. 18B illustrates the result when the thickness of a liquid crystal layer in the X direction for a comparative example of a liquid crystal display panel in related art is measured.

FIG. 19A illustrates the result when the thickness of a liquid crystal layer in the Y direction for an example of a laminated substrate for liquid crystal display panels according to one embodiment of the present invention is measured, and FIG. 19B illustrates the result when the thickness of a liquid crystal layer in the Y direction for a comparative example of a laminated substrate for liquid crystal display panels in related art is measured.

FIGS. 20A and 20B are perspective overviews to explain other examples of first bases.

FIG. 21 illustrates cross sections to explain a sub-step of bonding first and second mother bases in a manufacturing method of a laminated substrate for liquid crystal display panels in related art.

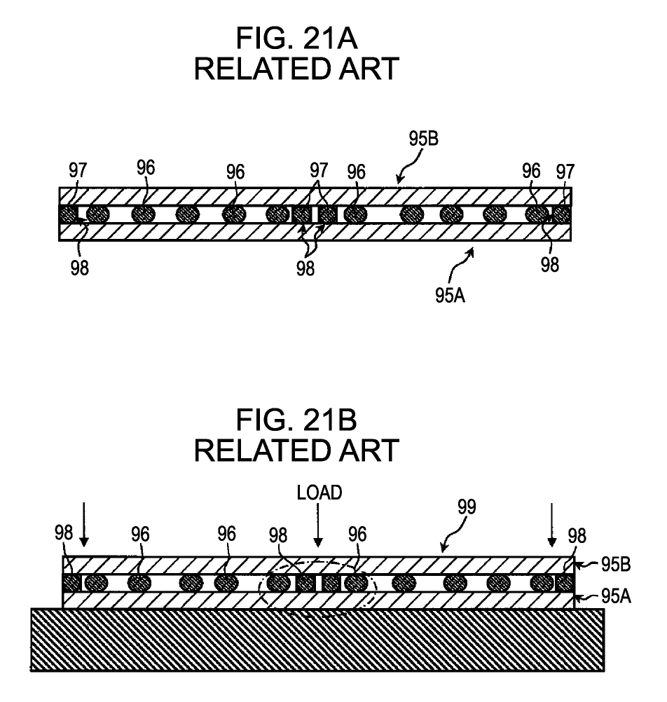

FIG. 22A is an enlarged cross section showing a part enclosed by a dotted chain line in FIG. 21B, and FIG. 22B is a cross section when a load, applied in FIG. 22A, is removed.

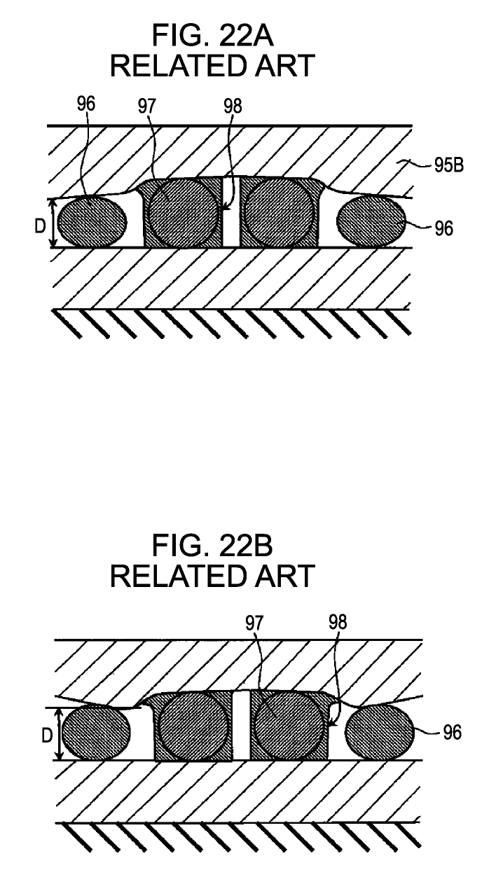

### REFERENCE NUMERALS

1 liquid crystal display device
2 liquid crystal display panel
2′ laminated substrate for liquid crystal display panels
20 first spacer (of liquid crystal display panel)
21 second spacer (of liquid crystal display panel)
20′ (first) spacer (of laminated substrate for liquid crystal display panels)
21′ (second) spacer (of laminated substrate for liquid crystal display panels)
22′ (fourth) spacer (of laminated substrate for liquid crystal display panels)
3 back light
4 first base
4′ first mother base
40 display region (of liquid crystal display panel)
40′ display region (of laminated substrate for liquid crystal display panels)
41 sealing region (of liquid crystal display panel)
42 peripheral region (of liquid crystal display panel)
42′ peripheral region (of laminated substrate for liquid crystal display panels)
43, 43A, 43B convex portion (of first base)
43′ convex portion (of first mother base)
43″ (second) convex portion (of first mother base)
44 first transparent substrate (of first base)
44′ first transparent mother substrate (of first mother base)
45 light shielding film (of first base)
45′ light shielding film (of first mother base)
45Aa opening (in light shielding film of first base)
45Aa′ opening (in light shielding film of first mother base)
46R, 46G, 46B (first) color filter (for display of first base)
46R′, 46G′, 46B′ (first) color filter (for display of first mother base)
46 (second) color filter (for convex portion of first base)
46′, 46″ (second) color filter (for convex portion of first mother base)
48 display electrode (of first base)
48′ display electrode (of first mother base)
5 second base
5′ second mother base
50 second transparent substrate (of second base)
50′ second transparent mother substrate (of second mother base)
51 display electrode (of second base)
51′ display electrode (of second mother base)
6 sealing member (of liquid crystal display panel)
6′ sealing member (of laminated substrate for liquid crystal display panels)
61 third spacer (of liquid crystal display panel)
61′ third spacer (of laminated substrate for liquid crystal display panels)

### BEST MODE FOR CARRYING OUT THE INVENTION

Hereinafter, exemplary embodiments of the present invention are described with reference to the drawings.

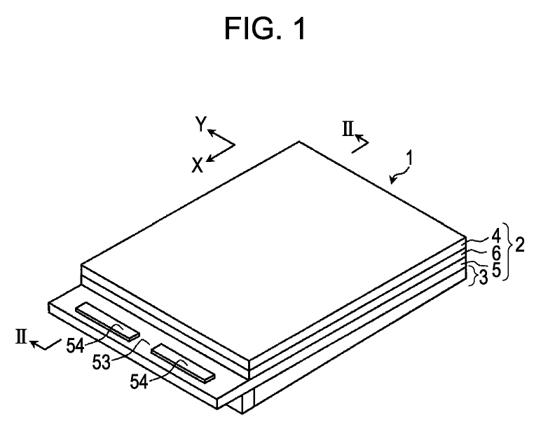

First, a liquid crystal display device and a liquid crystal display panel according to one embodiment of the present invention are described with reference to FIGS. 1 to 4.

A liquid crystal display device 1 shown in FIG. 1 includes a liquid crystal display panel 2 and a back light 3.

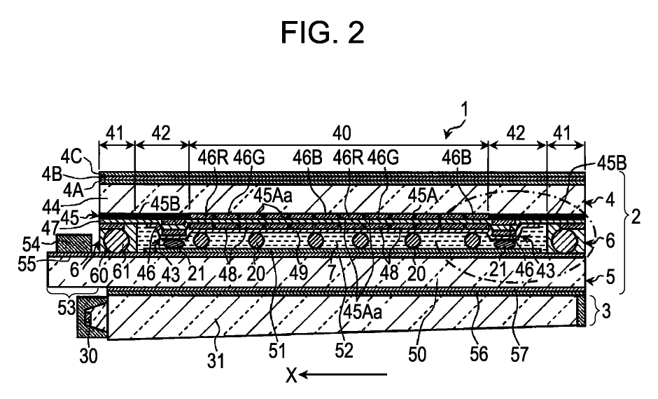

As shown in FIG. 2, the liquid crystal display panel 2 includes a first base 4, a second base 5, a plurality of spacers 20 and 21, a sealing member 6, and a liquid crystal layer 7.

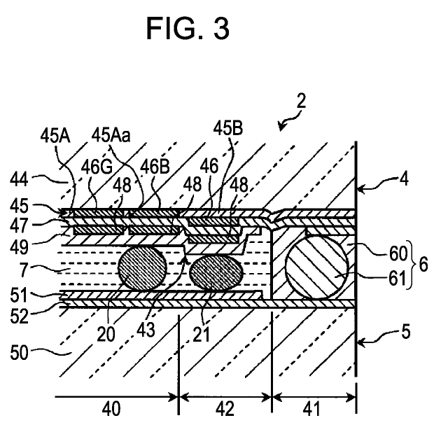

As shown in FIGS. 2 to 4, the first base 4 includes a convex portion 43 having a frame shape in a peripheral region 42, which is a region between a display region 40 and a sealing region 41 sealed by the sealing member 6, to enclose the display region 40 with the convex portion 43. The convex portion 43 reduces the depth of the depression in the peripheral region 42, and reduces the depth of the depression at the outer portion of the display region 40. As illustrated in FIGS. 2 and 3, the first base 4 includes a light shielding film 45, a plurality of color filters 46R, 46G, 46B, and 46, a flattening film 47, a plurality of display electrodes 48, and an alignment film 49, which are provided on a first transparent substrate 44.

The first transparent substrate 44 is a member that contributes to sealing of the liquid crystal layer 7. The first transparent substrate 44 is made of a material having a predetermined translucency (for example, a transparency which at least allows transmitted light to be visible), such as glass or translucent plastic. The thickness of the first transparent substrate 44 is, for example, 0.5 mm.

The light shielding film 45 restricts transmission of light, and has a first light shielding portion 45A in the display region 40, and a second light shielding portion 45B in the peripheral region 42. The first light shielding portion 45A has a matrix form with a plurality of openings 45Aa for pixel regions. For example, the light shielding film 45 is made of resin (for example, acrylic resin) with a dye or a pigment of a light-shielding color (for example, black) added, or light-shielding metal film, and has a thickness in a range from 1.0 to 2.0 μm. With this light shielding film 45, the contrast ratio of a displayed image can be increased.

The plurality of color filters 46R, 46G, 46B, and 46 include first color filters 46R, 46G, and 46B for display, and a second color filter 46 for a convex portion.

The first color filters 46R, 46G, and 46B for display are provided in the openings 45Aa of the first light shielding portion 45A, and have a band shape extending in the arrow Y direction in FIG. 1. The first color filters 46R, 46G, and 46B for display include a red color filter 46R for selectively transmitting red light, a green color filter 46G for selectively transmitting green light, and a blue color filter 46B for selectively transmitting blue light. For example, the red color filter 46R, the green color filter 46G, and the blue color filter 46B are arranged in the arrow X direction in that order.

The first color filters 46R, 46G, and 46B for display may be formed by filling the openings 45Aa of the first light shielding portion 45A with photosensitive resists, in which pigments are previously blended to obtain given colors (red, green, and blue), and then, by curing the photosensitive resists. The first color filters 46R, 46G, and 46B for display may selectively transmit light of cyan, magenta, and yellow. The first color filters 46R, 46G, and 46B for display in this case may be made of photosensitive resists with pigments of cyan, magenta, and yellow added. The thickness of the first color filters 46R, 46G, and 46B for display is, for example, in a range from 1.0 to 2.0 μm.

The second color filter 46 for the convex portion is provided on the second light shielding portion 45B, and has, for example, a rectangular frame shape. The second color filter 46 for the convex portion is made of a material equivalent to the material of one of the red color filter 46R, the green color filter 46G, and the blue color filter 46B. That is, the second color filter 46 for the convex portion may be made concurrently with one of the red color filter 46R, the green color filter 46G, and the blue color filter 46B. The second color filter 46 for the convex portion has a thickness similar to the first color filters 46R, 46G, and 46B for display, for example, in a range from 1.0 to 2.0 μm.

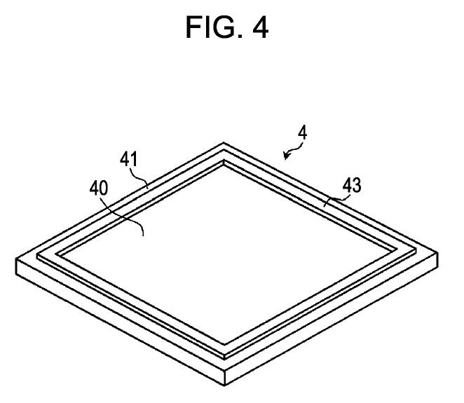

Since the second color filter 46 for the convex portion is provided on the second light shielding portion 45B, the second color filter 46 protrudes from the light shielding film 45 with respect to the first color filters 46R, 46G, and 46B for display. Hence, when the plurality of display electrodes 48 and the alignment film 49 are laminated on the second color filter 46 for the convex portion, a portion corresponding to the second color filter 46 for the convex portion defines a convex portion 43 which protrudes as compared with other portion (see FIG. 4]).

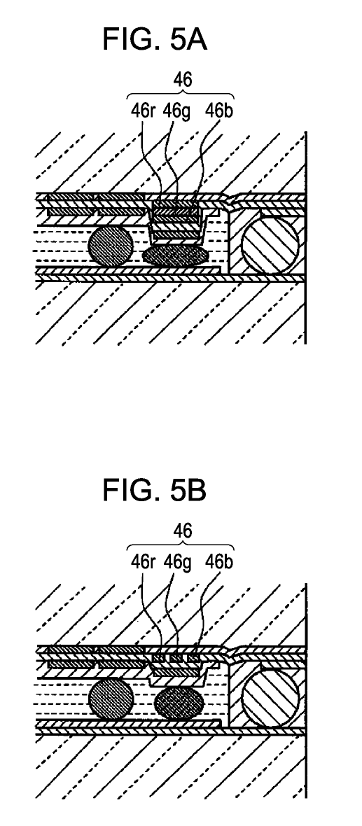

The second color filter 46 for the convex portion does not have to be made of the material equivalent to the material of one of the red color filter 46R, the green color filter 46G, and the blue color filter 46B. As shown in FIG. 5A, color filters 46r, 46g, and 46b, which are made of materials respectively equivalent to the materials of the three first color filters 46R, 46G, and 46B for display, may be laminated in the thickness direction, or may be arranged in the width direction. If the color filters 46r, 46g, and 46b are laminated in the thickness direction, the convex portion 43 may have a large thickness, which is advantageous to application of a larger load.

As shown in FIG. 2, the flattening film 47 reduces unevenness caused by the light shielding film 45 and the first color filters 46R, 46G, and 46B for display. The flattening film 47 covers the color filters 46R, 46G, 46B, and 46, and the light shielding film 45. The flattening film 47 is made of, for example, transparent resin such as acrylic resin.

The display electrodes 48 apply voltages to liquid crystal molecules. The display electrodes 48 may include a translucent conductive material, such as indium thin oxide (ITO) or tin oxide, and may have a band shape. Herein, the translucency is a property for allowing light to pass by a predetermined light quantity or more. The plurality of display electrodes 48 are arrayed in stripes arranged in parallel to each other. The thickness may be determined depending on the resistance, the light transmissivity, and the like. For example, the thickness of the display electrodes 48 is about 0.12 μm.

The alignment film 49 aligns the liquid crystal molecules, which are macroscopically randomly directed (with a low regularity), of the liquid crystal layer 7 in a predetermined direction. The alignment film 49 covers the flattening film 47 provided with the display electrodes 48. The alignment film 49 includes polyimide resin rubbed in a direction. The thickness of the alignment film 49 may be determined as desired. For example, the thickness may be about 0.05 μm.

While the alignment film 49 is directly provided on the display electrodes 48 in this embodiment, an insulating film including insulative resin, silicon dioxide (SiO₂), or the like, may be interposed between the alignment film 49 and the display electrodes 48. With this configuration, even if a conductive foreign substance enters between the display electrodes 48 of the first base 4 and below-described display electrodes 51 of the second base 5, insulation can be reliably kept between the display electrodes 48 and the display electrodes 51, which is advantageous to prevention of a defect in display pixels.

Also, the first base 4 has a first retardation film 4A, a second retardation film 4B, and a polarizing film 4C on a surface opposite to the surface with the display electrodes 48 and the like.

The first and second retardation films 4A and 4B compensate an optical-path difference (phase shift) caused by birefringence of the liquid crystal, and restrict coloring caused by wavelength dispersion. The first and second retardation films 4A and 4B may include, for example, polycarbonate.

The polarizing film 4C selectively transmits light which vibrates in a direction. Hence, with the polarizing film 4C, only light which vibrates in a specific direction can be emitted from the liquid crystal display panel 2. The polarizing film 4C may include an iodine material.

The first and second retardation films 4A and 4B, and the polarizing film 4C may be fixed to the first base 4 using a transparent adhesive member including, for example, a translucent acrylic material.

The second base 5 is bonded to the first base 4 in a manner facing to the first base 4 with the sealing member 6 interposed therebetween. The second base 5 includes display electrodes 51 and an alignment film 52 on a second transparent substrate 50.

The second transparent substrate 50 is a member that contributes to sealing of the liquid crystal layer 7. The second transparent substrate 50 has a terminal region 53 which protrudes to a lateral area of the first base 4. Driver ICs 54 for receiving image signals are mounted on the terminal region 53. The second transparent substrate 50 includes, for example, glass or transparent resin, similarly to the first transparent substrate 44. The second transparent substrate 50 is larger than the first transparent substrate 44 by the length of the terminal region 53, and has a thickness of, for example, 0.5 mm.

The display electrodes 51 apply voltages to the liquid crystal molecules together with the display electrode 48 of the first base 4. The display electrodes 51 have a band shape extending in a direction orthogonal to the display electrodes 48 of the first base 4. The plurality of display electrodes 51 are arrayed in stripes arranged in parallel to each other. That is, the plurality of display electrodes 51 intersect with the plurality of display electrodes 48 of the first base 4. The intersection regions are arranged in a matrix form. An intersection region of the display electrodes 48 and 51 defines a display pixel. That is, display pixels are arranged in a matrix form. A part of each display electrode 51 extends to the terminal region 53 of the second base 5, which protrudes to the lateral area of the first base 4. The part of each display electrode 51 located at the terminal region 53 serves as a terminal 55. The terminal 55 is connected to the driver IC 54, and receives an image signal and the like from the driver IC. The display electrode 51 includes a translucent conductive material, such as ITO or tin oxide, similarly to the display electrode of the first base 4, and has a thickness of, for example, about 0.12 μm.

The alignment film 52 aligns the liquid crystal molecules, similarly to the alignment film 49 of the first base 4. For example, the alignment film 52 includes polyimide resin rubbed in a direction. The alignment direction of the alignment film 52 intersects with the alignment direction of the alignment film 49. Assuming that the liquid crystal display panel 2 of one embodiment of the present invention employs STN display method, the intersection angle of the alignment films 49 and 52 is, for example, in a range from 200° to 260°.

Also, the second base 5 has a retardation film 56 and a polarizing film 57 on a surface opposite to the surface with the display electrodes 51 and the like, similarly to the first base 4.

As shown in FIGS. 2 and 3, the plurality of spacers 20 and 21 keep a distance between the first and second bases 4 and 5, that is, a thickness of the liquid crystal layer 7 uniform. The plurality of spacers 20 and 21 include first spacers 20 in the display region 40 and second spacers 21 on the convex portion 43. For example, the dispersion density thereof may range from 100 to 300 pieces per mm². The first and second spacers 20 and 21 include, for example, the same resin material, and have a spherical shape. The first and second spacers 20 and 21 have a diameter of, for example, in a range from 4 to 10 μm, and a compressive elastic modulus of, for example, 2500 to 10000 MPa by 10% K value. The resin material of the first and second spacers 20 and 21 is, for example, divinylbenzene resin.

The second spacers 21 are more compressed than the first spacers 20 because the second spacers 21 are located on the convex portion 43. Owing to this, the second spacers 21 have a larger elastic deformation ratio and a larger aspect ratio than those of the first spacers 20. Herein, the ratio of the elastic deformation ratio of the first spacers 20 to the second spacers 21 is, for example, in a range from 2 to 5. The aspect ratio of the first spacers 20 is, for example, in a range from 0.9 to 1.0. The aspect ratio of the second spacers 21 is, for example, in a range from 0.6 to 0.9.

The compressive elastic moduli by 10% K value of the first and second spacers 20 and 21 are values measured under the following conditions.

In particular, the 10% K values of the first and second spacers 20 and 21 were calculated by using Micro Compression Testing Machine (“PCT-200 type”, manufactured by Shimadzu Corporation) at room temperature, compressing particles corresponding to the first and second spacers 20 and 21 with a smooth end surface of a column made of diamond and having a diameter of 50 μm at a compression velocity of 0.27 gf/sec and a maximum test weighting of 10 gf, thus obtaining values of F, S, and R, and calculating the 10% K values with the following equation. In this equation, F denotes a load value (Kgf) by 10% compressive deformation of the particles, S denotes a compressive displacement (mm) by 10% compressive deformation of the particles, and R denotes a radius (mm) of the particles.

10% K value=(3/2^{1/2})·F·S^{-3/2}·R^{-1/2} [Equation 1]

The sealing member 6 seals the liquid crystal between the first and second bases 4 and 5, and bonds the first and second bases 4 and 5 with a predetermined gap interposed therebetween. The sealing member 6 has a resin portion 60 including thermosetting resin, and third spacers 61 included in the resin portion 60. The sealing member 6 has a rectangular frame shape extending along the outer portion of the first base 4. The third spacers 61 have a larger compressive elastic modulus than the first and second spacers 20 and 21. The compressive elastic modulus is, for example, in a range from 30000 to 100000 MPa by 10% K value. Accordingly, the thickness of the sealing member 6 is kept. The sealing member 6 is hardly deformed even when an external force is applied to the liquid crystal display panel 2. Hence, display irregularity caused by the variation of the thickness of the liquid crystal layer 7 can be reduced. The third spacers 61 include an inorganic material such as glass or silica, and have a columnar or spherical shape, with a height or diameter of, for example, in a range from 4 to 10 μm.

The compressive elastic modulus by 10% K value of the third spacers 61 is a value measured under the following conditions. In particular, the 10% K value of the third spacers 61 was calculated by using Micro Compression Testing Machine (“MCTM-200 type”, manufactured by Shimadzu Corporation) at room temperature, compressing particles corresponding to the third spacers 61 with a smooth end surface of a column made of diamond and having a diameter of 50 μm at a compression velocity of 1.44 gf/sec and a maximum test weighting of 30 gf, thus obtaining values of F, S, and R, similarly to the measurement of the first and second spacers 20 and 21, and calculating the 10% K value with the above-mentioned Equation 1.

Although the measurement method of the third spacers 61 is slightly different from that of the first and second spacers 20 and 21, the difference of the measurement method would not substantially affect the measurement result by 10% K value.

The liquid crystal layer 7 is a layer containing a liquid crystal which is electrically, optically, dynamically, or magnetically anisotropic, and has both regularity of a solid and fluidity of liquid. The liquid crystal layer 7 contains, for example, a nematic liquid crystal. The liquid crystal layer 7 is twisted by an angle, for example, in a range from 200° to 260° by way of the alignment films 49 and 52 of the first and second bases 4 and 5, so that the liquid crystal display panel 2 displays an image by the STN method. The liquid crystal layer 7 is formed by injecting, for example, a liquid crystal containing a chiral agent into a space between the bonded first and second bases 4 and 5. The liquid crystal may be a cholesteric liquid crystal, a smectic liquid crystal, or the like, other than the nematic liquid crystal.

As shown in FIG. 2, the back light 3 allows light to enter the display region 40 of the liquid crystal display panel 2. The light emitted from a light source 30 such as a light-emitting diode (LED), enters a light guiding member 31, and then is emitted upward from the light guiding member 31 in a planar manner. The back light 3 faces to the second transparent substrate 50 (second base 5) with the retardation film 56 and the polarizing film 57 interposed therebetween. The surface of the back light 3 facing to the second transparent substrate 50 (second base 5) may have a light diffusing layer. With this layer, the light from the light guiding member 31 can be emitted with a substantially uniform light distribution in the X and Y directions.

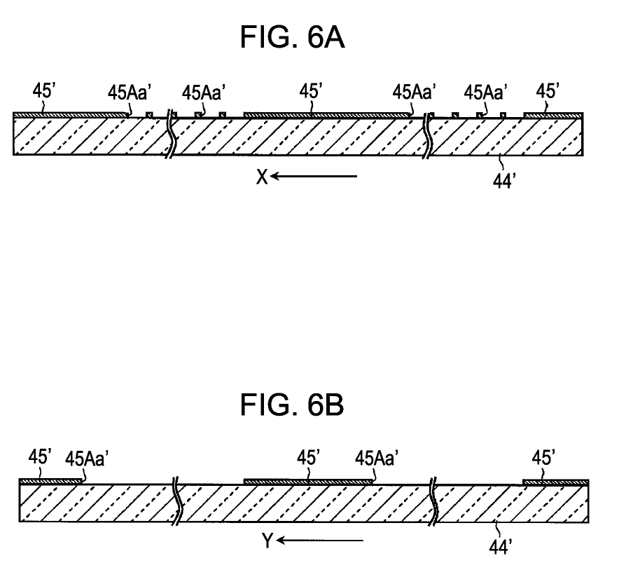

Next, a manufacturing method of the liquid crystal display panel 2 is described with reference to FIGS. 6 to 19.

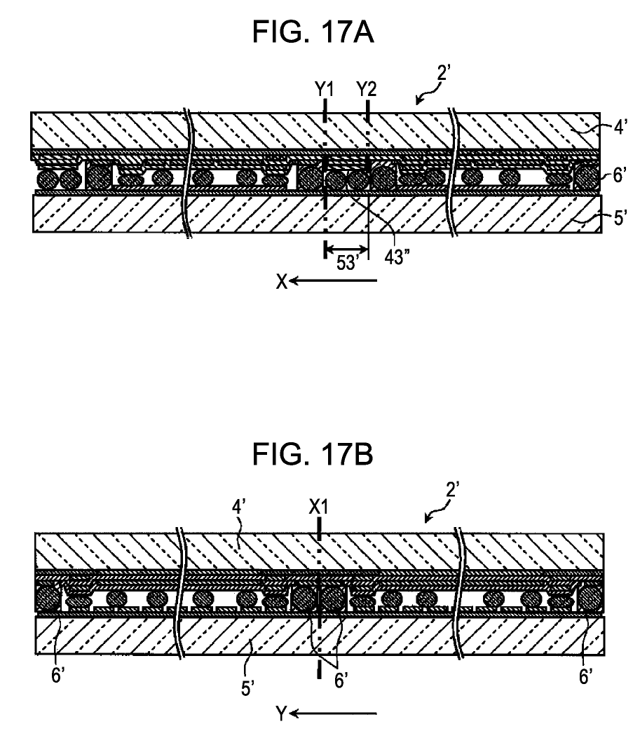

The liquid crystal display panel 2 shown in FIGS. 1 to 4 may be formed through the procedure that forming a laminated substrate 2′ for liquid crystal display panels (see FIGS. 17A and 17B), and then cutting the laminated substrate 2′ for liquid crystal display panels at predetermined cutting lines X1, Y1, and Y2.

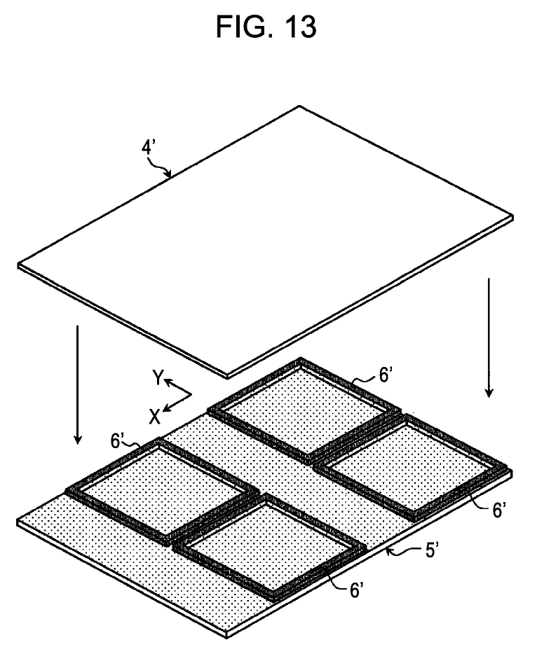

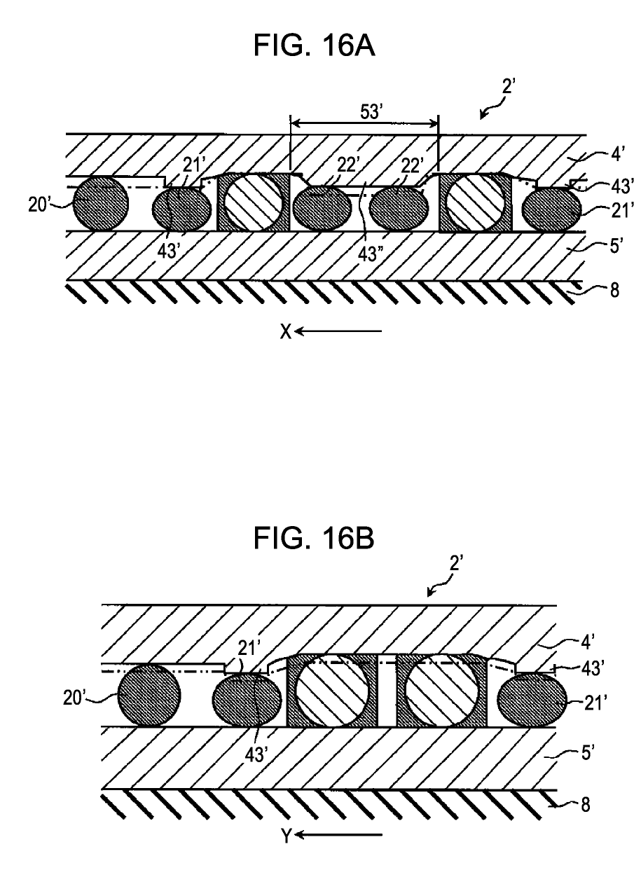

The laminated substrate 2′ for liquid crystal display panels shown in FIG. 17 may be formed through the procedure that forming a first mother base 4′ and a second mother base 5′, and then bonding the mother bases 4′ and 5′ with a sealing member 6′ and spacers 20′, 21′, and 22′ interposed therebetween (see FIGS. 13 and 16).

### [I] First Mother Base Formation Step

The first mother base formation step includes a light shielding film formation sub-step (A), a color filter formation sub-step (B), a flattening film formation sub-step (C), a display electrode formation sub-step (D), and an alignment film formation sub-step (E).

### (A) Light Shielding Film Formation Sub-Step

As shown in FIGS. 6A and 6B, the light shielding film formation sub-step is performed through forming a light shielding film 45′ having a plurality of openings 45Aa′ on a first transparent mother substrate 44′. FIG. 6A is a cross section along the X direction in FIG. 1, and FIG. 6B is a cross section along the Y direction in FIG. 1.

The light shielding film 45′ may be formed, for example, by applying a photosensitive resist containing a black pigment on the entire first transparent mother substrate 44′, and then forming the openings 45Aa′ by photolithography using a predetermined mask. The openings 45Aa′ are band-like slits arranged in the X direction and extending in the Y direction. The black pigment is previously dispersed in the photosensitive resist by pigment dispersing method. The application quantity of the photosensitive resist may correspond to a film thickness, for example, in a range from 1.0 to 2.0 μm. The light shielding film 45′ may include a light-shielding metal film. The openings 45Aa′ do not have to be a band shape, and may be a matrix form (reed shape) for individual pixels.

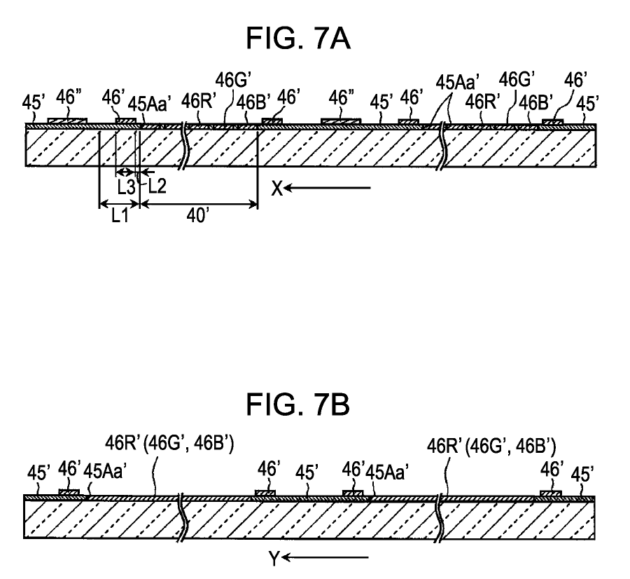

(B) Color Filter Formation Sub-Step As shown in FIGS. 7A and 7B, the color filter formation sub-step is performed through forming color filters 46R′, 46G′, and 46B′ in the plurality of openings 45Aa′ of the light shielding film 45′, and forming color filters 46′ and 46″ on predetermined regions of the light shielding film 45′. FIG. 7A is a cross section along the X direction in FIG. 1, and FIG. 7B is a cross section along the Y direction in FIG. 1.

The color filters 46R′, 46G′, and 46B′ correspond to the first color filters 46R, 46G, and 46B for display (see FIG. 2) of the liquid crystal display panel 2. The color filters 46R′, 46G′, and 46B′ may be formed, for example, by sequentially applying a photosensitive resist containing red, green, or blue pigment in the openings 45Aa′ of the light shielding film 45′, and then, performing photolithography using a predetermined mask. Thus, the color filters 46R′, 46G′, and 46B′ are provided in the openings 45Aa′ of the light shielding film 45′, as bands arranged in the X direction and extending in the Y direction. The red, green, or blue pigment is previously dispersed in the photosensitive resist by the pigment dispersing method. The application quantity of the photosensitive resist may correspond to a film thickness, for example, in a range from 1.0 to 2.0 μm. The color filters 46R′, 46G′, and 46B′ are substantially flush with the light shielding film 45′. If the openings 45Aa′ are formed in a matrix form (reed shape) for the individual pixels, instead of in a band shape, the color filters 46R′, 46G′, and 46B′ are formed in a matrix form (reed shape) for the individual pixels.

The color filter 46′ corresponds to the second color filter 46 for the convex portion (see FIGS. 2 and 3) of the liquid crystal display panel 2. The color filter 46′ can be formed by applying a photosensitive resist on a predetermined region of the light shielding film 45′ when the color filters 46R′, 46G′, and 46B′ are formed. Thus, the color filter 46′ can be formed concurrently with the color filters 46R′, 46G′, and 46B′. The color filter 46″ can be also concurrently formed with the color filters 46R′, 46G′, and 46B′.

The predetermined region of the light shielding film 45′ includes a portion corresponding to the rectangular-frame-like peripheral region 42 (convex portion 43) (see FIG. 2) between the display region 40 and the sealing region 41 in the liquid crystal display panel 2, and a portion corresponding to a band-like region (see FIG. 2) adjacent to the sealing member 6 in the terminal region 53.

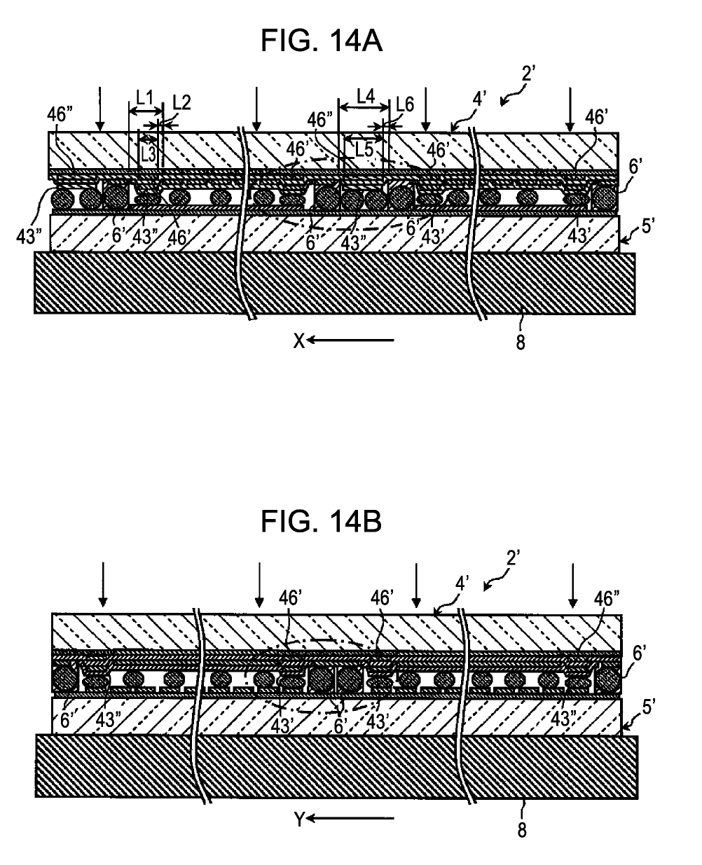

Since the color filters 46R′, 46G′, 46B′, 46′, and 46″ are formed in the openings 45Aa′ of the light shielding film 45′ and on the light shielding film 45′, the color filters 46′ and 46″ on the light shielding film 45′ protrude with respect to the color filters 46R′, 46G′, and 46B′ in the openings 45Aa′. Hence, the color filters 46′ and 46″ define below-described convex portions 43′ and 43″ of the laminated substrate 2′ for liquid crystal display panels (see FIGS. 14A and 14B).

In the color filters 46′ and 46″ on the light shielding film 45′, when the three color filters 46R′, 46G′, and 46B′ being formed, the three color filters may be horizontally arranged (see FIG. 5B), the three color filters 46R′, 46G′, and 46B′ may be laminated at the same position (see FIG. 5A), or one or two of the three color filters 46R′, 46G′, and 46B′ may be formed.

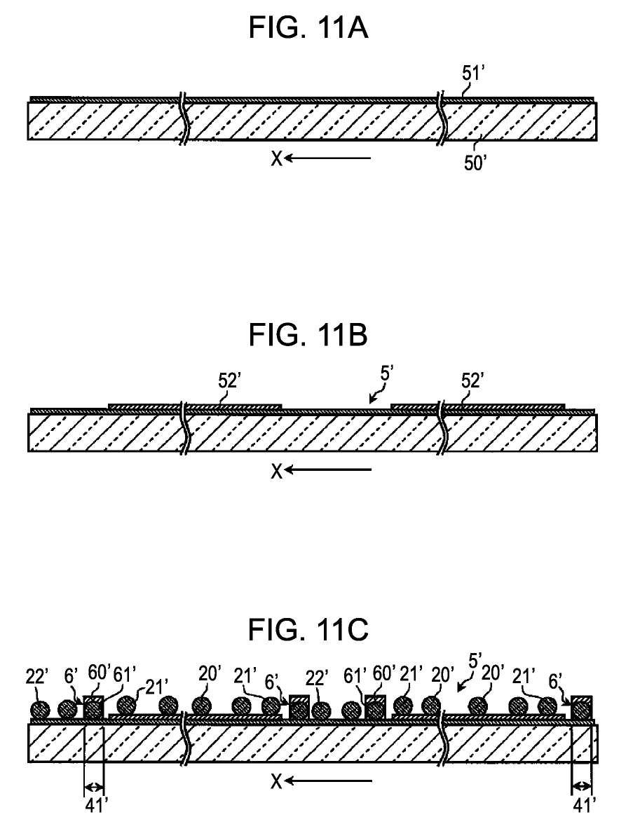

In the first mother base 4, a distance L1 from a region 40′ corresponding to the display region 40 (see FIG. 2) of the liquid crystal display panel 2 to the below-described sealing member 6′, a distance L2 from the region 40′ to the color filter 46′, and a width L3 of the color filter 46′ may be determined depending on the size of the liquid crystal display panel 2, the layout in the first mother base 4′, the film thickness of the color filters 46R′, 46G′, and 46B′, the process condition, and the like. Note that the width L3 of the color filter 46′ is preferably determined in a range from 5% to 60% of the distance L1. If the width L3 of the color filter 46′ is smaller than 5% of the distance L1, the surface area of the convex portion 43′ (see FIGS. 14A and 14B) becomes so small that the second spacer 21′ hardly remains on the convex portion 43′ during pressure bonding. The thickness of the liquid crystal layer 7 (see FIG. 2) may not be uniform. If the width L3 of the color filter 46′ is larger than 60% of the distance L1, a large number of second spacers 21′ may be present on the convex portion 43′. The thickness of the liquid crystal layer 7 (see FIG. 2) may be a predetermined value or larger in the periphery of the below-described sealing member 6′ (see FIG. 11C). The thickness of the liquid crystal layer 7 (see FIG. 2) may not be sufficiently flat. Also, the distance L2 from the region 40′ corresponding to the display region (see FIG. 2) to the color filter 46′ is preferably in a range of 0.05≦L2≦L1−L3 (mm).

In the first mother base 4′, a width L4 of a region corresponding to the terminal region 53 (see FIG. 2) of the liquid crystal display panel 2, a width L5 of the color filter 46″, and a distance L6 between the color filter 46″ and the sealing member 6′ may be appropriately designed similarly to the width L3 (see FIGS. 7A and 14A) of the color filter 46″. The width L5 of the color filter 46″, however, is preferably in a range from 10% to 70% of the width L4 of the region corresponding to the terminal region 53 (see FIG. 2). Also, the distance L6 between the color filter 46″ and the sealing member 6′ is preferably in a range of 0.2≦L6<L4−L5−0.1 (mm).

### (C) Flattening Film Formation Sub-Step

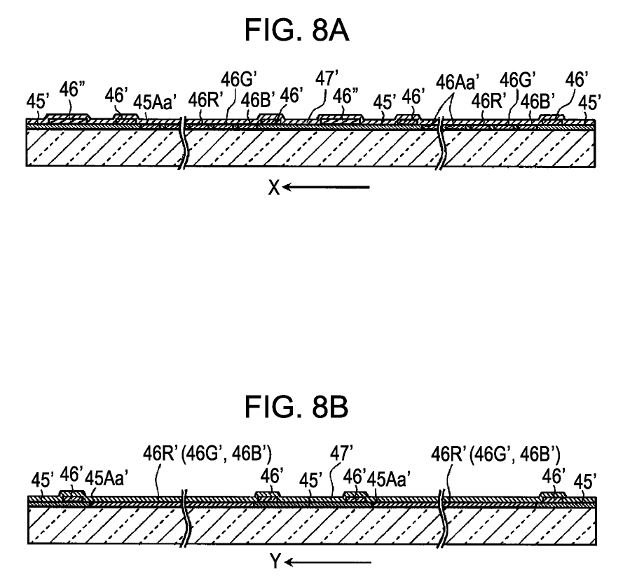

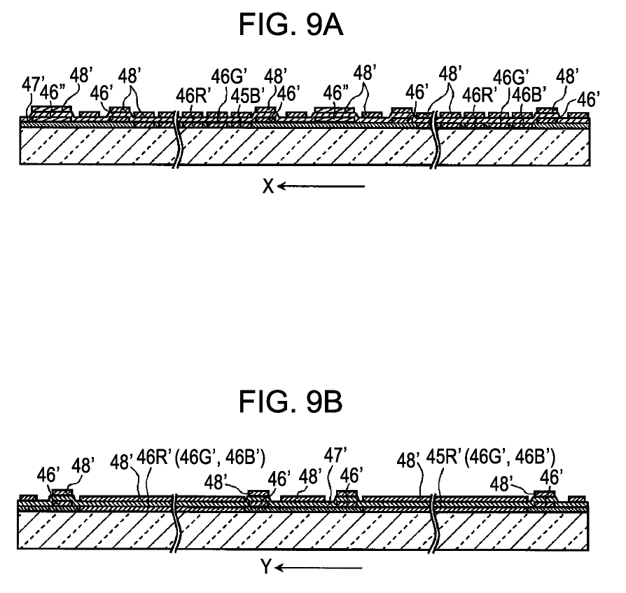

As shown in FIGS. 8A and 8B, the flattening film formation sub-step is performed through applying transparent resin such as acrylic resin so as to cover the light shielding film 45′ and the color filters 46R′, 46G′, 46B′, 46′, and 46″. The application quantity of the transparent resin may correspond to a thickness, for example, in a range from 1.0 to 5.0 μm. Since such a flattening film 47′ is formed, a step between the light shielding film 45′ and the color filters 46R′, 46G′, and 46B′ can be reduced, and the surface positions of display electrodes 48′ (see FIGS. 9A and 9B), which are formed later, can be uniform.

### (D) Display Electrode Formation Sub-Step

As shown in FIGS. 9A and 9B, the display electrode formation sub-step is performed through forming a plurality of display electrodes 48′ arranged in the X direction and extending in the Y direction on the flattening film 47′ in regions corresponding to the color filters 46R′, 46G′, 46B′, 46′, and 46″. The plurality of display electrodes 48′ may be formed by using a mask having openings in regions corresponding to the color filters 46R′, 46G′, and 46B′, and applying a translucent conductive component such as ITO or tin oxide to predetermined regions of the flattening film 47′, by a known film forming method such as depositing.

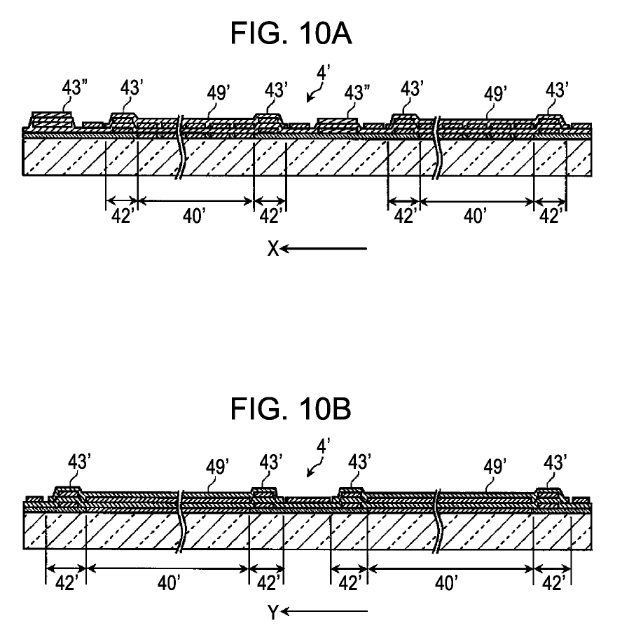

(E) Alignment Film Formation Sub-Step As shown in FIGS. 10A and 10B, the alignment film formation sub-step is performed through forming a resin layer including, for example, polyimide resin, by a known method, and then rubbing the resin layer in a direction to form an alignment film 49′. The alignment film 49′ (resin layer) is formed to cover the display region 40′ and a peripheral region 42′. In the alignment film formation sub-step, a previously rubbed resin sheet may be alternatively attached.

As described above, the light shielding film 45′, the color filters 46R′, 46G′, 46B′, 46′, and 46″, the flattening film 47′, the display electrodes (band-like conductive layer) 48′, and the alignment film (resin layer) 49′ are formed on the first transparent mother substrate 44′, and hence, the color filters 46′ and 46″ protrude with respect to the color filters 46R′, 46G′, and 46B′. Thus, in the first mother base 4′, the rectangular-frame-like region corresponding to the color filter 46′ defines a rectangular-frame-like convex portion 43′, and the band-like region corresponding to the color filter 46″ defines a convex portion 43″.

### [II] Second Mother Base Formation Step

The second mother base formation step includes a display electrode formation sub-step (A) and an alignment film formation sub-step (B).

### (A) Display Electrode Formation Sub-Step

As shown in FIG. 11A, the display electrode formation sub-step is performed through forming a plurality of display electrodes 51′ to be arranged in the Y direction (see FIG. 1) and extending in the X direction over the substantially entire area of a second transparent mother substrate 50′. That is, the display electrodes 51′ extend in a direction orthogonal to the display electrodes 48′ (see FIGS. 9A and 9B) of the first mother base 4′. The plurality of display electrodes 51′ are formed by using a mask having predetermined openings, and applying a translucent conductive component such as ITO or tin oxide to predetermined regions of the second transparent mother substrate 50′, by a known film forming method such as depositing.

### (B) Alignment Film Formation Sub-Step

As shown in FIG. 11B, the alignment film formation sub-step is performed through forming a resin layer including, for example, polyimide resin, by a known method, and then rubbing the resin layer in a direction to form an alignment film 52′. In the alignment film formation sub-step, a previously rubbed resin sheet may be alternatively attached. Note that the direction of rubbing the alignment film 52′ of the second mother base 5′ intersects with the direction of rubbing the alignment film 48′ of the first mother base 4′, so as to provide a twist for the liquid crystal layer 7 (see FIG. 2). For example, if the liquid crystal display panel 2 (see FIG. 2) employs the STN display method, the intersection angle between the direction of rubbing the alignment film 48′ of the first mother base 4′ and the direction of rubbing the alignment film (resin layer) 52′ of the second mother base 5′ is, for example, in a range from 200° to 260°.

### [III] Bonding Step of First Mother Base and Second Mother Base

The bonding step of first and second mother bases includes a sealing member formation sub-step for second transparent mother substrate (A), first and second spacers dispersion sub-step (B), and a thermo compression bonding sub-step (C).

### (A) Sealing Member Formation Sub-Step

As shown in FIG. 11C, the sealing member formation sub-step includes applying an application material, in which third spacers 61′ are included in thermosetting resin 60′, on a predetermined region of the second mother base 5′. The sealing member 6′ is substantially formed by curing the thermosetting resin contained in the application material in the below-described thermo compression bonding sub-step (C).

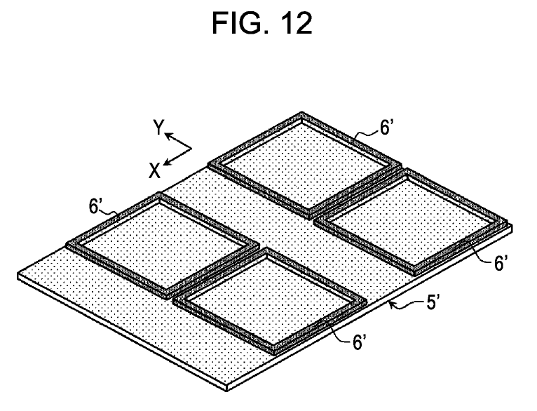

The thermosetting resin 60′ of the application material may be, for example, one-component epoxy resin having a curing temperature of about 150° C. The third spacers 61′ of the application material may be, for example, spherical silica particles having an average particle diameter in a range from 4 to 10 μm, and a compressive elastic modulus (10% K value) in a range from 30000 to 100000 MPa. The content of the third spacers 61′ in the application material may be, for example, in a range from 1.0 to 3.0 percent by weight. The predetermined region to which the application material is applied may correspond to the sealing region 41 (see FIG. 2) of the liquid crystal display panel 2. As shown in FIG. 12, for example, the predetermined region may have a frame shape with a width in a range from 0.6 to 1.0 mm.

### (B) First and Second Spacers Dispersion Sub-Step

As shown in FIG. 11C, the first and second spacers dispersion sub-step is performed through using a known, dry or wet spacer dispersion machine, and blowing spacers 20′, 21′, and 22′ to the second mother base 5′ through a nozzle. As shown in FIG. 12, the spacers 20′, 21′, and 22′ are dispersed over the substantially entire area of one of surfaces of the second mother base 5′.

The spacers 20′, 21′, and 22′ may be, for example, spherical particles including divinylbenzene resin, and having a diameter in a range from 4.0 to 10.0 w, and a compressive elastic modulus (10% K value) in a range from 2500 to 10000 MPa. The dispersion density of the spacers 20′, 21′, and 22′ may range from 100 to 300 pieces per mm². The diameter, the material, the dispersion density, and the like, of the spacers 20′, 21′, and 22′ may be appropriately selected depending on the size of the panel, the manufacturing condition of the panel, and the like.

### (C) Thermo Compression Bonding Sub-Step

As shown in FIGS. 13, 14A and 14B, the thermo compression bonding sub-step is performed through aligning the first and second mother bases 4′ and 5′ with each other, mounting them on a mount table 8 made of hard rubber or the like, applying a load from above to the first mother base 4′ by a pressure member (not shown), and heating them during the application of the load. FIG. 14A is a cross section along the X direction in FIG. 1, and FIG. 14B is a cross section along the Y direction in FIG. 1.

The load applied to the first mother base 4′ is, for example, in a range from 0.04 to 0.15 MPa. The heating temperature is a temperature for curing the thermosetting resin of the application material of the sealing member 6′ applied on the second mother base 5′. For example, when the resin with the curing temperature of about 150° C. is used, the heating temperature should be about 150° C.

When the first and second mother bases 4′ and 5′ are bonded by thermo compression bonding, the thermosetting resin in the application material of the sealing member 6′ is cured, the first and second mother bases 4′ and 5′ are bonded, and thereby the laminated substrate 2′ for liquid crystal display panels is formed.

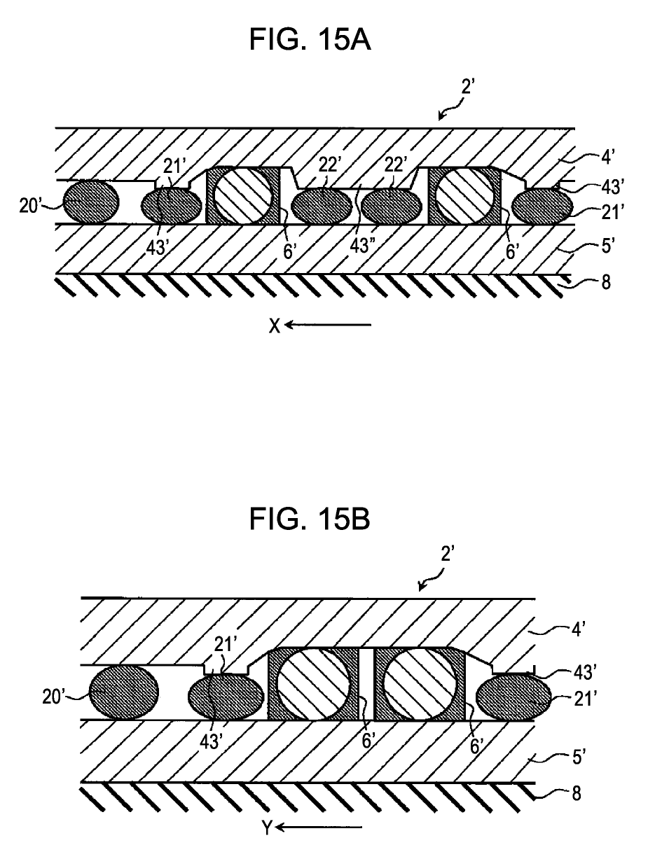

Herein, FIGS. 15A and 15B show the area near the sealing member 6′ with a load applied to the first mother base 4′, and FIGS. 16A and 16B show the area near the sealing member 6′ with the load, applied to the first mother base 4′, is removed. FIGS. 15A and 16A are cross sections showing a part enclosed by a dotted chain line in FIG. 14A. FIGS. 15B and 16B are cross sections showing a part enclosed by a dotted chain line in FIG. 14B.

As shown in FIGS. 15A and 15B, while a load is applied to the first mother base 4′, the spacers 20′, 21′, and 22′ are compressively deformed. At this time, since the spacers 21′ and 22′ are positioned at the convex portions 43′ and 43″, the spacers 21′ and 22′ are more deformed than the spacers 20′.

As shown in FIGS. 16A and 16B, when the load, applied to the first mother base 4′, is removed, the compressively deformed spacers 20′, 21′, and 22′ are elastically recovered. At this time, since the spacers 21′ and 22′ are positioned on the convex portions 43′ and 43″, the spacers 21′ and 22′ have a smaller elastic recovery amount than the spacers 20′. Accordingly, the spacers 21′ and 22′ have a larger elastic deformation ratio and a larger aspect ratio than the spacers 20′. As a result, a larger force is applied to the convex portions 43′ and 43″ as compared with other portion with the spacers 20′. Thus, the depression in the peripheral region of the laminated substrate 2′ for liquid crystal display panels can be shallower. The peripheral region corresponds to the display region 40 (see FIG. 2) of the liquid crystal display panel 2 In particular, if the convex portion 43″ is formed on a terminal region 53′ adjacent to the sealing member 6′, although it can be found through a below-described measurement example of the thickness of the liquid crystal layer 7, the depression caused by a sink of the portion corresponding to the terminal region 53′ of the first mother base 4′ can be further reliably shallower, as compared with a configuration only with the convex portion 43′.

The laminated substrate 2′ for liquid crystal display panels is cut along cutting lines Y1 and Y2 extending in the Y direction as shown in FIG. 17A, and along cutting lines X1 and X2 extending in the X direction as shown in FIG. 17B. The liquid crystal is injected into a space between the first and second mother bases 4′ and 5′ and defined by the sealing member 6′. Thus, the liquid crystal display panel 2 shown in FIGS. 1 to 4 is formed. As shown in FIG. 17A, the convex portion 43″ provided in the first mother base 4′ at the portion corresponding to the terminal region 53′ is removed when the laminated substrate 2′ for liquid crystal display panels is cut. The liquid crystal may be injected before the laminated substrate 2′ for liquid crystal display panels is cut, instead of after cutting. Alternatively, only the first mother base 4′ may be cut at a predetermined position and the liquid crystal may be injected while the terminal region 53′ is exposed.

With the liquid crystal display panel 2 thus obtained, the depression in the peripheral region 42 of the laminated substrate 2′ for liquid crystal display panels is shallower. The peripheral region 42 corresponds to the display region 40. Therefore, the depression at the outer portion of the display region 40 can be shallower. Accordingly, in the liquid crystal display panel 2, the thickness of the liquid crystal layer 7 including the outer portion of the display region 40 can be kept uniform, and hence, display irregularity can be prevented from appearing at the outer portion of the display region. In particular, if the convex portion 43′ (43) has a frame shape, the depression in the entire peripheral region 42 of the display region 40 can be shallower, and the depression at the entire outer portion of the display region 40 can be shallower. As a result, the thickness of the liquid crystal layer 7 can be further reliably kept uniform. The display irregularity can be further reliably reduced at the outer portion of the display region 40.

Also, in the laminated substrate 2′ for liquid crystal display panels, since the convex portion 43″ is formed to enclose the sealing member 6′ with the convex portion 43″, the depression caused by the sink of the portion of the first mother base 4′ corresponding to the terminal region 53′ can be appropriately shallower. Accordingly, in the liquid crystal display panel 2 obtained by the laminated substrate 2′ for liquid crystal display panels, the thickness of the liquid crystal layer 7 can be further reliably be kept uniform. The display irregularity can be further reliably reduced at the outer portion of the display region 40.

The convex portion 43′ may be formed in the peripheral region 42′, and the convex portion 43″ may be formed on the portion (which is removed later) corresponding to the terminal region 53′. Accordingly, since the laminated substrate 2′ for liquid crystal display panels does not have to additionally have regions for the convex portions 43′ and 43″, forming the convex portions 43′ and 43″ does not increase the size of the laminated substrate 2′ for liquid crystal display panels, and the liquid crystal display panel 2.

The convex portion 43′ may be formed simply by providing the light shielding film in the first mother base 4′ also in the peripheral region 42′, and providing the color filter 46′ on the light shielding film 45′ in the peripheral region 42′. Similarly, the convex portion 43″ may be formed simply by providing the color filter 46″ on the region corresponding to the terminal region 53. Accordingly, with the liquid crystal display panel 2 obtained from the laminated substrate 2′ for liquid crystal display panels, the thickness of the liquid crystal layer 7 in the display region 40 can be kept uniform without increasing the manufacturing worker-hour. The display irregularity caused by the depression at the outer portion of the display region 40 can be reduced.

As mentioned above, the measurement results of the thickness of the liquid crystal layer in an example of the laminated substrate 2′ for liquid crystal display panels, and in an example of the liquid crystal display panel 2 are concerned.

To form the laminated substrate 2′ for liquid crystal display panels, the first spacers 20′, the second spacers 21′, and the fourth spacers 22′ employed spherical particles including divinylbenzene resin, and having a diameter of 5.6 μm and a compressive elastic modulus (10% K value) of 5960 MPa. The dispersion density of the spacers 20′, 21′, and 22′ were 200 pieces per mm². In the first mother base 4′, the distance L1 was 2.0 mm, the distance L2 was 0.438 mm, the width L3 was 0.219 mm, the width L4 was 7.06 mm, the width L5 was 2.5 mm, and the distance L6 was 2.28 mm, these distances and widths being illustrated in FIG. 14A.

As the thickness of the liquid crystal layer of the laminated substrate 2′ for liquid crystal display panels, the laminated substrate 2′ for liquid crystal display panels without the retardation films 4A, 4B, and 56, and the polarizing films 4C and 57 was measured in the X direction. The thickness of the liquid crystal display panel 2 was measured in the Y direction.

The thickness of the liquid crystal layer was measured by a measuring machine, A30 of “RETS-2000”, manufactured by Otsuka Electronics Co., Ltd., under the measurement conditions of a room temperature of 25° C., a gate time of 350 msec, a nominal wavelength range from 400 to 800 nm, an inclination angle setting of 0° to 0°, and a measurement wavelength of 589 nm.

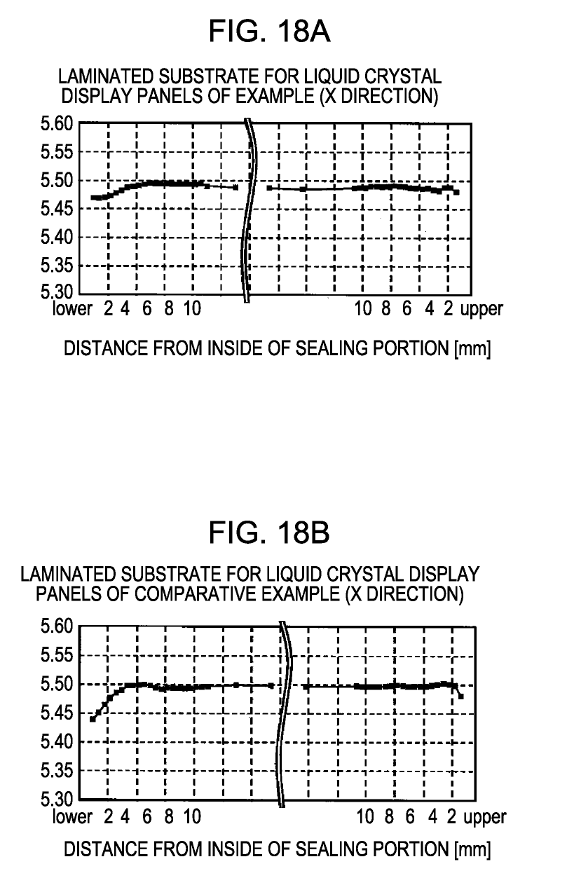

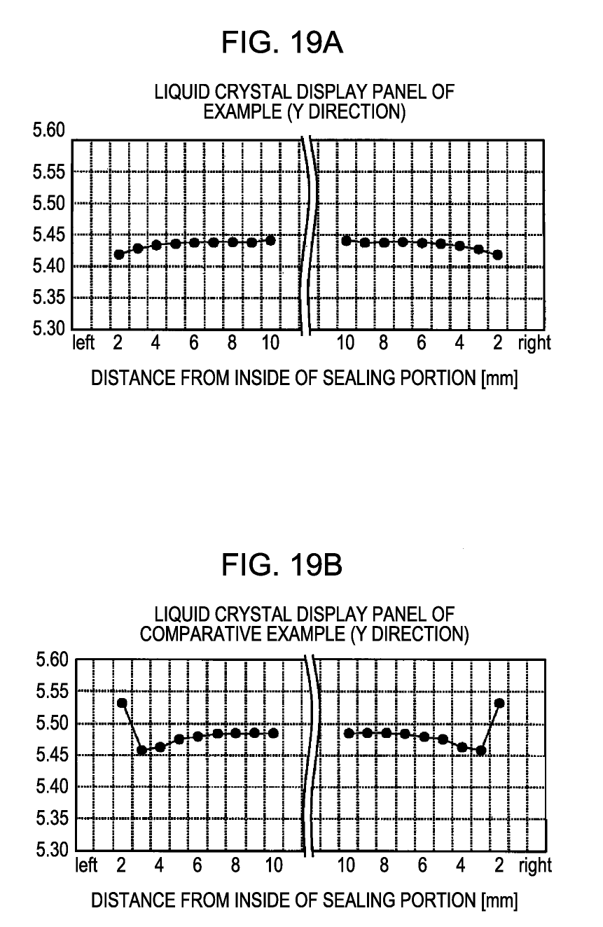

The measurement result of the thickness of the liquid crystal layer of the laminated substrate 2′ for liquid crystal display panels is shown in FIG. 18A. FIG. 18A is the measurement result at a portion corresponding to the outer portion of the display region 40, in a cross section along the X direction in FIG. 1 for the example of the of laminated substrate 2′ for liquid crystal display panels of one embodiment of the present invention. The measurement result of the thickness of the liquid crystal layer 7 of the liquid crystal display panel 2 is shown in FIG. 19A. FIG. 19A is the measurement result at a portion corresponding to the outer portion of the display region 40, in a cross section along the Y direction in FIG. 1 for the example of the liquid crystal display panel 2 of one embodiment of the present invention.

As a comparative example, the thickness of a liquid crystal layer in a laminated substrate for liquid crystal panels without convex portions 43′ and 43″ was measured in the X direction, and the thickness of the liquid crystal layer in a liquid crystal display panel obtained by dividing the laminated substrate for liquid crystal display panels was measured in the Y direction. The laminated substrate for liquid crystal display panels of the comparative example was formed in a similar manner to the liquid crystal display panel 2 of the present invention except for the absence of the convex portions 43′ and 43″. The measurement result of the thickness of the liquid crystal layer in the X direction for the comparative example of the laminated substrate for liquid crystal display panels in related art is shown in FIG. 18B. The measurement result of the liquid crystal layer in the Y direction for the comparative example of the liquid crystal display panel in related art is shown in FIG. 19B.

In the measurement results in FIGS. 18A and 18B, the result, in which the distance from the inner side of the sealing portion is plotted as 1.25 mm, corresponds to the thickness of the liquid crystal layer at the outermost portion of the display region.

As shown in FIG. 18A, in the example of the laminated substrate 2′ for liquid crystal display panels of one embodiment of the present invention, the thickness of the liquid crystal layer 7 at the outer portion of the display region 40 was kept substantially uniform although it slightly decreased toward the edge (point plotted as 1.25 mm) of the display region 40.

This result can be obtained because, in the laminated substrate 2′ for liquid crystal display panels of one embodiment of the present invention as shown in FIG. 15A, the convex portions 43′ and 43″ serve as supports, whereby the depression in the terminal region 53′ of the first mother base 4′ can be shallower during thermo compression bonding, and the sealing member 6′ can be prevented from being obliquely cured and bonded. As a result, as shown in FIG. 16A, the convex portion 43′ on the light shielding film 45′ between the display region 40′ and the sealing member 6′ serves as the support. The depression at outer portion of the display region 40′ in the first mother base 4′ can be shallower, and the thickness of the liquid crystal layer in the display region 40′ can be further kept uniform.

In contrast, as shown in FIG. 18B, in the comparative example of the laminated substrate for liquid crystal display panels of related art, the thickness of the liquid crystal layer at the outer portion of the display region seriously decreased at the outermost portion of the display region. The thickness of the liquid crystal layer increased toward the display region, and then became uniform. The thickness frequently varied in the entirety.

As shown in FIG. 19A, in the example of the liquid crystal display panel 2 of one embodiment of the present invention, the thickness of the liquid crystal layer 7 at the outer portion of the display region was kept substantially uniform although it slightly decreased toward the edge (point plotted as 2.0 mm) of the display region 40. In contrast, as shown in FIG. 19B, in the comparative example of the liquid crystal display panel of related art, the thickness of the liquid crystal layer at the outer portion of the display region seriously decreased toward the edge of the display region. The thickness of the liquid crystal layer 7 was large at the outermost portion of the display region, and a depression appeared at the outer portion of the display region.

As described above, in the example of the laminated substrate 2′ for liquid crystal display panels of one embodiment of the present invention with the convex portions 43′ and 43″ (color filters 46′ and 46″), a decrease (depression) in the thickness of the liquid crystal layer at the outer portion of the display region 40′ is reduced as compared with the comparative example of the laminated substrate for liquid crystal display panels without the convex portions 43′ and 43″ (color filters 46′ and 46″) in related art.

Also, in the example of the liquid crystal display panel 2 of one embodiment of the present invention, display irregularity was not recognized when the presence of display irregularity in the peripheral region of the display region 40 was checked with eyes. In contrast, in the comparative example of the liquid crystal display panel of related art, display irregularity was recognized with eyes at the outer portion of the display region. Thus, in the example of the liquid crystal display panel 2 of one embodiment of the present invention, since the depression in the peripheral region 42 of the display region 40 is reduced, display irregularity is appropriately reduced, and the display quality can be improved.

In the above description, a specific embodiment of the present invention is provided; however, the present invention is not limited thereto. Various modifications may be made within the scope of the invention.

The present invention does not have to be applied to the above-described super twisted nematic (STN) liquid crystal display panel, and may be applied to other liquid crystal display panels, such as a twisted nematic (TN) liquid crystal display panel, a triple super twisted nematic (TSTN) liquid crystal display panel, and a film super twisted nematic (FSTN) liquid crystal display panel.

The present invention does not have to employ a passive matrix driving system, and may employ other driving system such as an active matrix driving system. Also, the retardation films and the polarizing films are not essential components. For example, the retardation films may be omitted in the TFT method, and one of the polarizing films may be omitted in a reflective liquid crystal display panel.

Further, in the embodiment, while the first color filter for display has a band shape extending in the direction (Y direction) along the display electrodes in the first base, the first color filter for display may have a band shape extending in the direction (X direction) along the display electrodes of the second base.

In the present invention, while the convex portion is provided by the color filter, the convex portion may be provided by other element instead of the color filter. Alternatively, the color filter may be provided at a base different from the base provided with the convex portion.

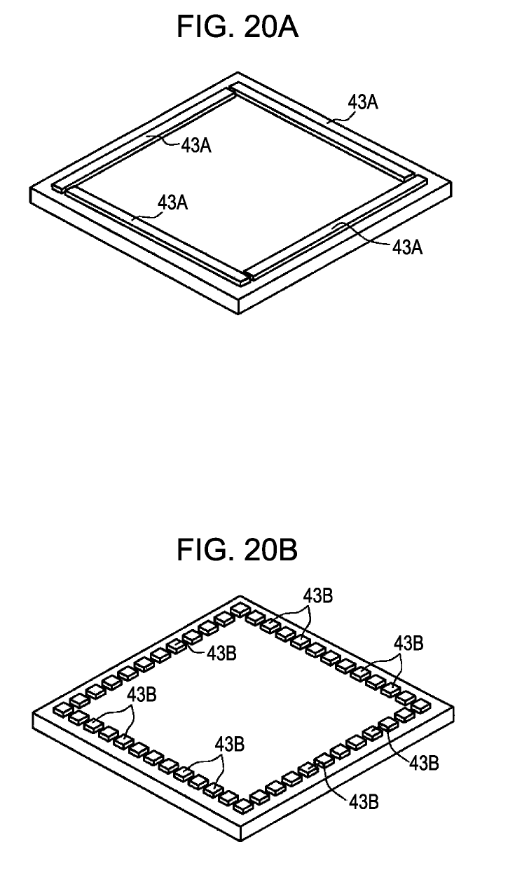

The convex portion 43 of the first base 4 is only required to enclose the periphery of the display region with the convex portion 43, and does not have to have a rectangular frame shape. For example, as shown in FIG. 20A, the convex portion may include four individual band-like convex portions 43A. Alternatively, as shown in FIG. 20B, the convex portion may include a plurality of discretely arranged blocks 43B. The convex portion enclosing the display region may be provided at the second base, instead of the first base.

1. A liquid crystal display panel comprising:
a first base comprising a light shielding film, a plurality of color filters, and a first display electrode on a first transparent substrate;
a second base comprising a second display electrode on a second transparent substrate;
a plurality of spacers for keeping a distance between the first and the second bases; and
a sealing member for sealing a liquid crystal between the first and the second bases,
wherein at least one of the first and the second bases comprises a convex portion between a display region including a plurality of display pixels and a sealing region sealed by the sealing member, to enclose the display region with the convex portion, and
wherein the spacers comprise a first spacer in the display region and a second spacer on the convex portion.

2. A liquid crystal display panel according to claim 1,
wherein the convex portion has a frame shape.

3. A liquid crystal display panel according to claim 1,
wherein the color filters comprise a first color filter for display in an opening of the light shielding film and a second color filter on the light shielding film, for forming the convex portion.

4. A liquid crystal display panel according to claim 1,
wherein the sealing member comprise a third spacer having a larger compressive elastic modulus than the first and the second spacers.

5. A liquid crystal display panel comprising:
a first base comprising a light shielding film, a plurality of color filters, and a first display electrode on a first transparent substrate;
a second base comprising a second display electrode on a second transparent substrate;
a plurality of spacers for keeping a distance between the first and the second bases; and
a sealing member for sealing a liquid crystal between the first and the second bases,
wherein the spacers comprise a first spacer in a display region including a plurality of display pixels and a second spacer between the display region and a sealing region sealed by the sealing member, and
wherein the second spacer has a larger elastic deformation ratio than the first spacer.

6. A liquid crystal display panel according to claim 5,
wherein the sealing member comprises a third spacer having a larger compressive elastic modulus than the first and the second spacers.

7. A liquid crystal display panel comprising:
a first base comprising a light shielding film, a plurality of color filters, and a first display electrode on a first transparent substrate;
a second base comprising a second display electrode on a second transparent substrate;
a plurality of substantially spherical or spheroidal spacers for keeping a distance between the first and the second bases; and
a sealing member for sealing a liquid crystal between the first and the second bases,
wherein the spacers comprise a first spacer in a display region including a plurality of display pixels and a second spacer between the display region and a sealing region sealed by the sealing member, and
wherein the second spacer has a larger aspect ratio than the first spacer.

8. A liquid crystal display panel according to claim 7,
wherein the sealing member comprise a third spacer having a larger compressive elastic modulus than the first and the second spacers.

9. A liquid crystal display device comprising:
a liquid crystal display panel comprising a first base and a second base; and
a back light facing to the first base or the second base, wherein
the first base comprises a light shielding film, a plurality of color filters, and a first display electrode on a first transparent substrate,
the second base comprises a second display electrode on a second transparent substrate,
the liquid crystal display panel comprises a sealing member for sealing a liquid crystal between the first and the second bases and a plurality of spacers for keeping a distance between the first and the second bases,
at least one of the first and the second bases has a convex portion between a display region including a plurality of display pixels and a sealing region sealed by the sealing member, to enclose the display region with the convex portion, and
the spacers comprise a first spacer in the display region and a second spacer on the convex portion.

10. A liquid crystal display device according to claim 9,
wherein the convex portion has a frame shape.

11. A liquid crystal display device according to claim 9,
wherein the color filters comprise a first color filter for display in an opening of the light shielding film and a second color filter on the light shielding film, for forming the convex portion.

12. A liquid crystal display device according to claim 9,
wherein the sealing member comprise a third spacer having a larger compressive elastic modulus than the first and the second spacers.

13. A liquid crystal display device comprising:
a liquid crystal display panel comprising a first base and a second base; and
a back light facing to the first base or the second base, wherein
the first base comprises a light shielding film, a plurality of color filters, and a first display electrode on a first transparent substrate,
the second base comprises a second display electrode on a second transparent substrate,
the liquid crystal display panel comprises a sealing member for sealing a liquid crystal between the first and the second bases and a plurality of spacers for keeping a distance between the first and the second bases,
the spacers comprise a first spacer in a display region including a plurality of display pixels and a second spacer between the display region and a sealing region sealed by the sealing member, and
the second spacer has a larger elastic deformation ratio than the first spacer.

14. A liquid crystal display device according to claim 13,
wherein the sealing member comprise a third spacer having a larger compressive elastic modulus than the first and the second spacers.

15. A liquid crystal display device comprising:
a liquid crystal display panel comprising a first base and a second base; and
a back light facing to the first base or the second base, wherein
the first base comprises a light shielding film, a plurality of color filters, and a first display electrode on a first transparent substrate,
the second base comprises a second display electrode on a second transparent substrate,
the liquid crystal display panel comprises a sealing member for sealing a liquid crystal between the first and the second bases and a plurality of substantially spherical or spheroidal spacers for keeping a distance between the first and the second bases,
the spacers comprise a first spacer in a display region including a plurality of display pixels and a second spacer between the display region and a sealing region sealed by the sealing member, and
the second spacer has a larger aspect ratio than the first spacer.

16. A liquid crystal display device according to claim 15,
wherein the sealing member comprises a third spacer having a larger compressive elastic modulus than the first and the second spacers.

17. A laminated substrate for liquid crystal display panels, comprising:
a first mother base comprising light shielding films, color filters, and first display electrodes on a first transparent mother substrate;
a second mother base comprising second display electrodes on a second transparent mother substrate;
spacers for keeping a distance between the first and the second mother bases; and
sealing members for sealing liquid crystals between the first and the second mother bases,
wherein at least one of the first and the second mother bases comprises convex portions between display regions including display pixels and sealing regions sealed by the sealing members to enclose the display regions with the convex portions, and
wherein the spacers comprise first spacers in the display regions and second spacers on the convex portions.

18. A laminated substrate for liquid crystal display panels according to claim 17,
wherein each of the convex portions has a frame shape.

19. A laminated substrate for liquid crystal display panels according to claim 17,
wherein the color filters comprise first color filters for display in openings of the light shielding films and second color filters on the light shielding films, for forming the convex portions.

20. A laminated substrate for liquid crystal display panels according to claim 17,
wherein the sealing members comprise third spacers having a larger compressive elastic modulus than the first and the second spacers.

21. A laminated substrate for liquid crystal display panels according to claim 17,
wherein at least one of the first and the second mother bases comprises second convex portions in regions enclosing the sealing regions, and
the spacers comprise fourth spacers on the second convex portions.

22. A laminated substrate for liquid crystal display panels, comprising:
a first mother base comprising light shielding films, color filters, and first display electrodes on a first transparent mother substrate;
a second mother base comprising second display electrodes on a second transparent mother substrate;
spacers for keeping a distance between the first and the second mother bases; and
sealing members for sealing liquid crystals between the first and the second mother bases,
wherein the spacers comprise first spaces between display regions including display pixels and second spacers between the display regions and sealing regions sealed by the sealing members, and
wherein the second spacers have a larger elastic deformation ratio than the first spacers.

23. A laminated substrate for liquid crystal display panels according to claim 22,
wherein the sealing members comprise third spacers having a larger compressive elastic modulus than the first and the second spacers.

24. A laminated substrate for liquid crystal display panels, comprising:
a first mother base comprising light shielding films, color filters, and first display electrodes on a first transparent mother substrate;
a second mother base comprising second display electrodes on a second transparent mother substrate;
spacers for keeping a distance between the first and the second mother bases; and
sealing members for sealing liquid crystals between the first and the second mother bases,
wherein the spacers comprise first spaces between display regions including display pixels and second spacers between the display regions and sealing regions sealed by the sealing members, and
wherein the second spacers have a larger aspect ratio than the first spacers.

25. A laminated substrate for liquid crystal display panels according to claim 24,
wherein the sealing members comprise third spacers having a larger compressive elastic modulus than the first and the second spacers.
